(19) United States
(12) Patent Application Publication
(10) Pub. No.: US 2006/0045072 A1
(43) Pub. Date: Mar. 2, 2006

(54) Method of managing telephone calls over a data network, telephony station, server and telephony system supporting said method

(76) Inventors: Emmanuel Chevrier, Limours (FR); Jean-Pierre Mercuriali, Orsay (FR)

Correspondence Address: MCCRACKEN & FRANK LLP, 200 W. ADAMS STREET, SUITE 2150, CHICAGO, IL, 60606, US

(21) Appl. No.: 10/950,728

(22) Filed: Sep. 27, 2004

(30) Foreign Application Priority Data
Aug. 25, 2004 (FR) 04 09087

(51) Int. Cl. H04L 12/66; H04L 12/56

(52) U.S. Cl. 370/352; 370/401

(57) ABSTRACT

The invention proposes a bidirectional interchange of information between a telephony station and a PROXY to interchange signaling protocol messages 103, 105-108, 110. This bidirectional interchange between the telephony station and the PROXY remains permanent and independent of the establishment of a telephone call. The protocol messages interchanged permanently between the telephony station and the PROXY are short messages that indicate the tones to be used and the DTMF signals. Preferentially, the protocol messages correspond to subscription service notification messages. Following the startup of the telephony station 98, the telephony station subscribes 99 with the server to a tone service, and the server subscribes 100 with the telephony station to a key press event service.

### FIELD OF THE INVENTION

The invention relates to telephony over a computer network. More particularly, the invention relates to the management of a telephone call in a telephony system comprising at least one telephony station connected to the network and having to communicate with a server to establish a telephone call.

### BACKGROUND OF THE INVENTION

Telephony over a computer network is currently growing vigorously. Specifically, the latter is a less costly alternative to the conventional analog telephone network. Currently, different solutions are used, in particular within companies that use the computer network as a telephone network. Equally, certain operators propose carrying out telephony via the INTERNET. Telephony station should therefore be understood to be either a specific telephone intended to be connected directly to a computer network, for example of the INTRANET or INTERNET type, or a computer provided with an interface allowing a user to carry out dialog phonically, for example a headset and a microphone, or even a gateway between a conventional analog network and a network of the INTRANET or INTERNET type.

Amongst the solutions used at the present time, the one which seems to be best suited to telephony over the computer network is defined in the RFC (Request For Comment) No. 2833 defined by the IETF (INTERNET Engineering Task Force). According to RFC2833, telephony is initiated with the aid of the SIP (Session Initiation Protocol) protocol defined in RFC3261 of the IETF. One of the major advantages of the SIP protocol is that it can be used to pass through firewalls and equally through address translation devices. When a telephone call is established, the telephony station, irrespective of its type, contacts an agent server (commonly called a PROXY) to establish the call with a remote station. The data interchanges are first made with the aid of the SIP protocol in combination with the SDP (Session Description Protocol) protocol which opens a session according to the RTP (Real Time Protocol) protocol which is used for data packet management corresponding to an audio channel. Every call results, on the one hand, in a bidirectional transmission between the calling telephony station and the PROXY and, on the other hand, between the PROXY and the remote station. When a call has been established, an RTP session is opened and data packets of the RTP type are sent both for signaling information and for sound information representative of the telephone call. Such implementations are described for example in American patents U.S. Pat. No. 6,298,055 and U.S. Pat. No. 6,456,618, in the “Design and Implementation of a SIP-based VOIP Architecture” article by S. Zeadally and F. Siddiqui, Proceedings of the 18th International Conference on Advanced Information Networking and Application, IEEE-AINA 2004, and also in the “Session Initiation Protocol” article of KK tan and HL Goh, IEEE ICIT 2002.

Such a system has some disadvantages, in particular when the requirement is to fully emulate the operation of an analog station or stimuli station. A first disadvantage is that when the call is established and equally during an established call, signaling data are transmitted via an audio channel. Now, amongst these signaling data, it can be pointed out that there is on the one hand information from the PROXY and to the telephony station to supply the tone to be reproduced for the user, and on the other hand control signals of the DTMF (Dual Tone Multi Frequency) type which represent sound codes of key presses on a telephone keypad. The use of the audio channel to transfer this type of information is relatively constricting because it occupies a considerable bandwidth whereas these information items are relatively few in number. In thus, in the case of the DTMF signals, if the latter are transmitted by sound means and the sound channel is itself compressed, these signals may be modified by the compression algorithm and may become incomprehensible after decompression. In addition, in an established call, the audio channel is established from end to end between the calling station and the called station. A PROXY can no longer intervene on this signaling information unless the call systematically passes through the PROXY, which is not done in order to avoid doubling the bandwidth necessary for the call.

U.S. Pat. No. 6,771,641 partially resolves the problems indicated above by sending protocol messages according to the SIP protocol to transmit the DTMF messages between a point A and a point B. These messages are sent in parallel with the audio channel established in order to avoid a distortion or a loss of these signals due to the compression of the sound data. The protocol messages are of the INFO type as defined in RFC2976 of the IETF. However, these messages are sent in parallel with the channel and, in an established call, the latter do not pass through the PROXY.

Furthermore, it is known, through RFC3265 of the IETF, to be possible to use a subscription mechanism with the aid of the SIP protocol.

### SUMMARY OF THE INVENTION

The invention proposes a solution to the problems and disadvantages previously cited by using a bidirectional exchange of information between a telephony station and a PROXY to exchange signaling protocol messages independently of the establishment of a telephone call. This bidirectional exchange between the telephony station and the PROXY remains permanent and independent of the establishment of a telephone call between a calling telephony station and a remote called telephony station. The protocol messages exchanged permanently between the telephony station and the PROXY are data messages occupying little bandwidth which indicate on the one hand the tones to be used and on the other hand the DTMF signals.

Thus the invention is a method of managing telephone calls over a data network comprising at least one server and at least one telephony station, the data network supporting at least one data protocol distinct from a communication protocol. Following a startup of the telephony station, the establishment of the call is initiated by a reciprocal exchange of protocol messages between the telephony station and the server, said protocol messages being of a first type and of a second type. The protocol messages of the first type are always exchanged between the telephony station and the server. The protocol messages of the second type are, in a first time, exchanged between the telephony station and the server, then, in a second time, between the telephony station and a station known as remote when the call is established. Said protocol messages of the first type sent by the telephony station to the server are protocol messages relating to key press events. Said protocol messages of the first type sent by the server to the telephony station are messages representative of the tones which are to be heard by a user of the telephony station in order to inform him of the state of establishment of the telephone call. Said protocol messages of the first type conform with the data protocol.

Preferentially, preference is given to short messages which are used to provide a supervision of the link between the telephony station and the PROXY by using notification messages corresponding to a subscription service. Prior to the first protocol message, the telephony station subscribes with the server to a tone service and the server subscribes with the telephony station to a key press event service.

For this, the data protocol provides the possibility of subscribing to services. Thus, following the startup of the telephony station and prior to the exchange of protocol messages, the telephony station subscribes to a tone service with the server according to the data protocol, said service supplying the protocol messages representative of the tones, and the server subscribes to an event service with the telephony station according to the data protocol, said service supplying the protocol messages relating to key press events.

The notification messages are very short messages that occupy very little bandwidth. Furthermore, another advantage of the subscription is that the latter has a predetermined lifetime but it can be renewed so long as the call is not finished. A subscription to a service should be understood to be any service request having a limited duration in time such as, for example the mechanism of the SIP protocol using the SUBSCRIBE and NOTIFY messages defined in RFC3265 of the IETF, or any other type of subscription equivalent to that described in RFC3265.

Preferentially, the protocol messages representative of the tones comprise a code identifying the tone and/or a description of the tone which is to be heard by the user of the telephony station. Where appropriate, several successive descriptions are sent simultaneously to describe a complex tone. The protocol messages relating to key press events comprise at least one code representative of an event created by the pressing of a control key by a user on the telephony device and/or a description of a sound associated with an event created by the pressing of a control key by a user on the telephony device.

According to another aspect, the invention is a telephony station comprising means of connection to a data network that supports at least one communication protocol and one data protocol allowing subscription to a service. The telephony station comprises subscription means intended for subscribing, following its startup on the data network, to a tone service with a server connected to the network, the tone service supplying notifications of tones in protocol message form, and notification means intended to send event notifications in the form of protocol messages to the server, following a subscription by the server to an event service with the telephony station.

According to yet another aspect, the invention is a server comprising means of connection to a data exchange network which supports at least one communication protocol and one data protocol allowing subscription to a service. The server comprises notification means intended to send tone notifications in the form of protocol messages to a telephony station connected to the network, following a subscription by the telephony station to a tone service with the server, and subscription means intended to subscribe to an event service with the telephony station connected to the network, following a detection of startup of the telephony station or following the subscription by the telephony station to the tone service, the event management service supplying event notifications in protocol message form.

More generally, the invention is a telephony system comprising at least one server and at least one telephony station.

The invention will be better understood and other features and advantages will appear on reading the following description, making reference to the appended figures in which:

### BRIEF DESCRIPTION OF THE DRAWINGS

FIGS. 1 to 4 represent various network configurations implementing the invention,

FIG. 5 represents an example of notification exchange between a telephony station and a PROXY.

### DETAILED DESCRIPTION OF THE PREFERRED EMBODIMENTS

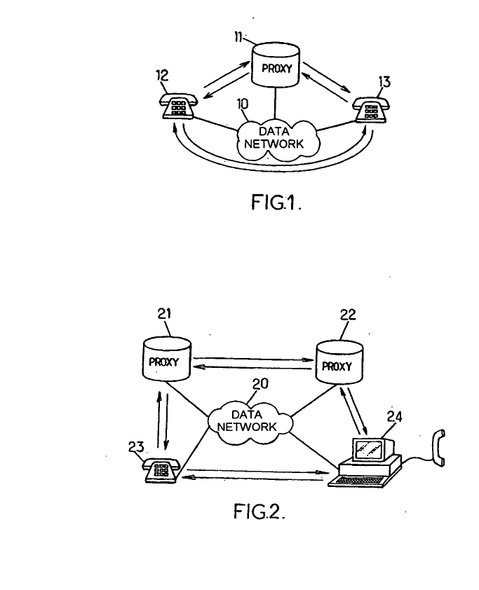

FIG. 1 represents a first network configuration implementing the invention. The data network 10 is for example a network of the INTRANET type, for example that of a company, which will support the internal telephone communication function. A server of a PROXY type 11 is used as a point of access of a telephone service within said network. Two telephony stations 12 and 13 are directly connected to the network 10. Naturally, the installation may comprise a much larger number of stations which it is not necessary to show in detail for the invention to be understood. Each telephony station 12 and 13 is provided with interface means making it possible to communicate over said network.

When they are started up, each of the telephony stations 12 and 13 sends a subscription request to the PROXY 11 to subscribe to the tone services. The PROXY 11 will grant the subscription to the stations 12 and 13. The PROXY 11 will then subscribe to an events service with the stations 12 and 13 in order to retrieve the DTMF commands from the stations 12 and 13. So long as the telephony stations 12 and 13 are in service, that is connected to the network and powered up, the subscriptions will be renewed by the stations and by the PROXY 11. If ever one of the stations is taken out of service, the PROXY 11 is informed thereof during a resubscription operation which will not be able to be completed. The PROXY 11 receiving no acknowledgement to its subscription request considers that the subscription has not been completed.

To establish a call between the two telephony stations 12 and 13, the calling station, for example the station 12, will contact the PROXY 11 to establish the call with the station 13. When the station 12 off-hooks, the latter sends a line seizure information message. The PROXY 11 will then send a line available tone notification within the network 10 to the station 12. The user using the station 12 will then dial the telephone number for the station 13. The station 12 will send in succession to the PROXY 11 the codes of the keys pressed. The PROXY 11 will search in an internal table for the physical address on the network of the station 13 and contact the latter. If the station 13 is available, the PROXY 11 sends a tone to the station 12 indicating that the telephone 13 is contacted and is awaiting the off-hook. When the telephone 13 off-hooks, the station 13 sends a handset off-hook information message. The PROXY 11 ascertaining that the station 13 is on line sends to the station 12 an invitation to open the channel with the station 13 by supplying the network address of the station 13. The station 12 will then communicate with the station 13 directly via messages emulating an audio stream between the two stations 12 and 13.

During the call between the station 12 and the station 13, the PROXY 11 will regularly send resubscription requests to the stations 12 and 13 for the event subscription services. Reciprocally, the stations 12 and 13 will equally regularly renew their subscription to the tone services with the PROXY 11. It will be noted that the message exchanges linked to the subscriptions between the PROXY 11 and the stations 12 and 13 are restricted to small messages occupying little bandwidth independently of the call between the stations 12 and 13.

If ever during the call one of the users of one of the stations 12 or 13 decides to make a complex call, for example to have a telephone conference or answer another call, the user can do it by pressing the keys on his telephone and by thus sending the corresponding notifications directly to the PROXY 11.

The operation of a call seizure will be described in greater detail later.

FIG. 2 represents a second network configuration implementing the invention. This network configuration implements a data network 20 spread over at least two remote sites. Each site has its own PROXY type server. One PROXY 21 being on a first site and one PROXY 22 being on a second site. A telephony station 23 is situated in the first site, the PROXY 21 establishing its calls. The second telephony station 24 is situated on the second site, the PROXY 22 establishing its calls. Those skilled in the art will notice here that the telephony station 24 is for example a computer provided with an interface performing the telephone function. This interface consists for example of a headphone and a microphone connected to a sound card of the computer according to a known technique. It should be noted that the data network 20 here is shown as a single network but that the latter may very easily consist of two pieces of network of the INTRANET type specific to a company and connected to one another via the INTERNET network.

When it is started up, the station 23 will subscribe to a tone service with the PROXY 21. The PROXY 21 reciprocally subscribes to an event service with the station 23 in order to receive the key press commands. Equally when it is started up, the station 24 will subscribe to the tone service of the PROXY 22 and the PROXY 22 will reciprocally subscribe to the event service of the station 24. The PROXYs to be contacted are entered in each of the stations 23 and 24 during an initialization of these stations by a qualified operator.

If a user of the station 23 wants to establish a call with the station 24, the user using the station 23 will off-hook the handset. When the handset is off-hooked, the station 23 sends a line seizure information message to the PROXY 21. The PROXY 21 sends a line availability tone notification to the station 23 so that the user begins dialing. When the user using the station 23 has typed the telephone number he wants to obtain, the PROXY 21 will search in a table containing this telephone number. The PROXY 21 will then contact the PROXY 22 to which the station 24 is linked. The PROXY 22 will then contact the station 24 and send to the PROXY 21 messages concerning the state and communication capability of the station 24. If the station 24 is available, the PROXY 22 indicates this to the PROXY 21, the PROXY 21 then sending a ringing tone to the station 33. If the station 24 is busy, the PROXY 22 indicates this to the PROXY 21 which will send a station busy tone. If a user decides to establish the call from the station 24, the station 24 informs the PROXY 22 that the handset has been off-hooked. The PROXY 22 will then contact the PROXY 21 to indicate thereto that the station 24 is ready to take the call and supply thereto the network address that corresponds to the station 24. The PROXY 21 will relay the invitation to the station 23 and the station 23 will then open an audio channel directly with the station 24. The messages exchanged between the stations 23 and 24 are audio messages. The messages exchanged, on the one hand, between the station 23 and the PROXY 21 and, on the other hand, between the station 24 and PROXY 22 will be messages of SIP type corresponding to the subscriptions which will be messages of purely protocol type. It should be noted that the PROXY 21 and the PROXY 22 do not need to communicate with one another during the call between the stations 23 and 24.

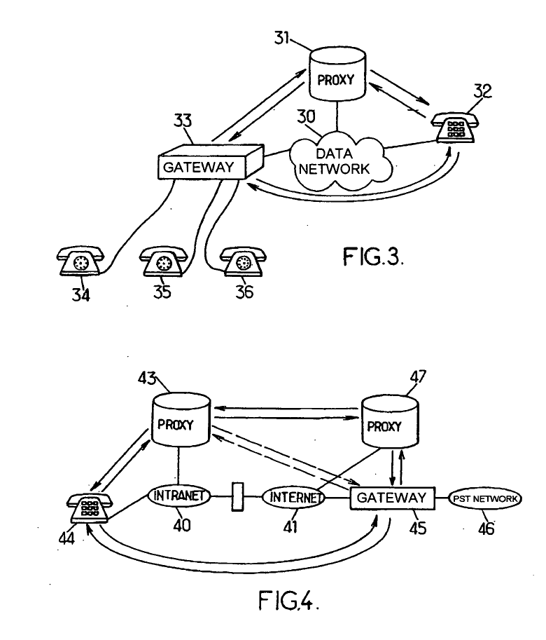

FIG. 3 illustrates a third network configuration implementing the invention. A PROXY 31 is connected to a network 30. A station 32 is equally connected to this same network 30 and an analog/network gateway 33 is itself connected to the network 30. Three analog stations 34, 35 and 36 are connected to the gateway 33 so that the latter serves as an interface between them and the data networks. For this invention, it should be considered that the gateway 33 is a full telephony station but having as many lines as there are analog stations connected to it. Specifically, the latter will manage the transmission of messages with the various analog stations 34 to 36 in order to convert them into messages compatible with the data network 30. The latter will use the PROXY 31 in the same manner as a telephony station such as the station 32.

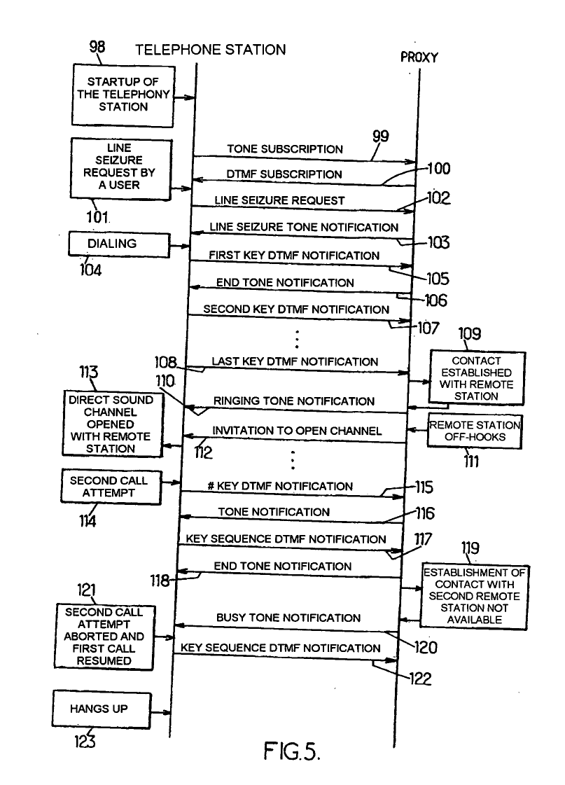

FIG. 4 represents a fourth network configuration implementing the invention. In this FIG. 4, an INTRANET network 40 is connected to an INTERNET type network 41 via a firewall 42. On the INTRANET network 40, there is a PROXY 43 and a plurality of telephony stations 44 only one of which is shown in said FIG. 4. Furthermore, a gateway 45 is connected between the INTERNET network 41 and the conventional analog telephony network 46. A PROXY 47 is used to manage the establishment of the calls between the conventional network 46 and the INTERNET network 41. For the establishment of a call, the station 44 will communicate with the PROXY 43 to establish the calls. The gateway 45 will communicate with the PROXY 47 to establish the calls. The PROXYs 43 and 47 will communicate with one another for the establishment of calls depending on stations that they manage. And the calls will pass directly between the station 44 and the gateway 45 which will then be considered to be a simple telephony station. The PROXY 47 may be directly integrated into the gateway 45; in this case, the PROXY 43 will communicate directly with the gateway 45 as indicated by the dashed arrows.

It should be noted that the use of a PROXY to establish the calls, both the calling calls and the called station calls, is necessary because on the INTRANET 40 or INTERNET 41 type networks, the network addresses may not be fixed. In this case, only the PROXY 43 or 47 may establish the correspondence with the physical network address of the station concerned. In the case in FIG. 4, the gateway 45 will emulate several telephony stations, each station corresponding to a line on the network 46. The PROXY 47 then makes the correspondence between the various lines and the various addresses. In the case of the gateway 45, the latter may interface a predetermined number of lines simultaneously, for example 256 telephone lines out of a greater number of lines. The correspondence between telephone line and Internet addresses is made dynamically, addresses being allocated by the PROXY. Conventionally, this type of configuration is used for calls between telephones connected to networks and conventional telephones. The advantage of such a system is that it is used to greatly reduce the telephone calling costs by using the INTERNET network for long distances, the gateway being for example a local telephone exchange. In such a case, the PROXY 43 will analyze the telephone number that a user wishes to obtain on the station 44 and contact the PROXY 47 which is used to make the correspondence between the gateways and the analog telephone numbers corresponding to said gateways.

Now in a little greater detail the mechanism of establishing a call by a telephony station will be given. FIG. 5 illustrates this call establishment. The left portion of this figure corresponds to events specific to the telephony station, the right portion to events specific to the PROXY associated with the station and the various arrows connecting the left portion and the right portion correspond to message exchanges between the telephony station and the PROXY in chronological manner from the top down. As an example, the telephony station in question is for example the station 12 and the PROXY is for example the PROXY 11. However, the station and PROXY references are not indicated in what follows because what follows may equally apply to the station 23 and the PROXY 21, or to any station described in FIGS. 1 to 4 and to the PROXY associated with it, considering that the telephony station is the calling station.

Following a startup event 98, the telephony station sends a subscription request 99 to the tone service of the PROXY. This request is sent with the aid of the SIP protocol according to a subscription request format, for example with the aid of a SUBSCRIBE message, specifying that it involves the tone service. A response from the PROXY is automatically sent in response to the telephony station to indicate thereto that the subscription has indeed taken effect. This acknowledgement request is for example an OK message which is not shown in the figure to avoid overloading the latter unnecessarily. Furthermore, thereafter, each message sent from the PROXY to the telephony station and reciprocally from the telephony station to the PROXY is normally accompanied by an OK type message in return signifying that said message has been correctly received. The OK message is the acknowledgement message of the SIP protocol, which is sent after receiving any kind of message. These messages will not necessarily be indicated hereafter but will always be present when each message is received.

The PROXY having received the subscription request and having acceded to this tone subscription request, the latter will subscribe in return to an event service in order to receive the DTMF type signals emitted by the telephony station. This subscription request 100 is also sent according to the SIP protocol and according to a subscription request format specifying that it involves a key event service. An acknowledgement of the subscription is emitted by the telephony station.

The subscriptions are requested for a predefined duration and at the end of each predefined duration a resubscription request is emitted. The resubscription requests correspond to subscription requests which are not shown in order to avoid unnecessarily overloading the figure. If ever the telephony station is taken out of service by disconnection from the network or disconnection of its power supply, the station will not resubscribe and the PROXY can no longer resubscribe to the telephony station. The failure to subscribe by the PROXY is detected by the non-detection of the acknowledgement of the subscription. The PROXY may then indicate in one of its tables that the station is not in the network, which furthermore is used to avoid having to search for it if the latter is called.

Following an event of line seizure by a user 101, a line seizure request message 102 is sent to the PROXY by the telephony station. This message is for example a message of the INFO type according to the SIP protocol as is already known for establishing a telephone call. The PROXY accedes to the line seizure by sending a first tone notification message 103 notifying that the line seizure is effective. This tone notification 103 corresponds to the tone code or to the description of the tone that the user using the telephony station is to be made to hear. It should be noted that, if the PROXY and the telephony station correspond to a private network connected to an INTRANET, this line seizure tone may be of a first type and/or of a second type when the requirement is to connect to the outside of the private network.

The user hearing the tone signifying to him that the line is available will begin his dialing during step 104. The telephony station will then send a first event notification message 105 corresponding to the DTMF signal of the first key. Since the line is not available at that time, the PROXY will send a tone notification message 106 indicating that the tone must stop. If on the other hand the situation were of a private telephony network and this first key corresponded to a request to seize a line to an outside network, it is then possible to send another tone indicating that a line is available for communicating with the outside. Such a tone may be sent only after verification that an outside line is available.

The user will continue to dial and event notifications 107 to 108 in succession will give notification of the events corresponding to the presses on the second, third keys, etc up to the last key.

When a complete telephone number has been received by the PROXY, the PROXY carries out a step 109 of establishing contact with a remote station, this step corresponds to the call to the remote station.

Contact is established with a remote station, on the one hand following the analysis of the telephone number dialed by the user on the telephony station and, on the other hand, with correspondence tables specific to the PROXYs. If the telephone number is identified as being a number of a telephone dependant on the PROXY, for example in the case of a PROXY emulating an exchange on an INTRANET type network, then the PROXY will contact the remote station of its network to begin establishing the call. If the telephone number is identified as being a number of a telephone corresponding to another PROXY or corresponding to an analog telephone number, the PROXY will contact another PROXY upon which the management of this number depends. Whatever the situation concerning the number of the remote station, the PROXY in response, either directly from the remote station, or from a PROXY managing the remote station, will give notification of a ringing tone if the station is available. The notification is sent with the aid of a message 110 to the telephony station. As will be indicated hereafter, this notification may be of different type and it will be repeated as many times as necessary until a remote station off-hook event 111 that will be indicated to the PROXY either directly by the remote station or by the PROXY on which it depends. Following the remote station off-hook event 111, the PROXY will send a message 112 inviting the opening of a channel, for example with the aid of an INVITE message. The telephony station will then, during a step 113, communicate with the aid of the RTP protocol with the remote station to transport the audio streams. The audio streams are established between the telephony station and the remote station and do not pass through the PROXY or PROXYs.

During the call between the telephony station and the remote station, the subscriptions to the tone and event services are regularly renewed between the PROXY and the telephony station according to the SIP protocol.

According to a particular configuration, the user using the telephony station may make a three-party call. The latter makes his second call attempt during a step 114 pausing the call with the remote station for example by pressing the # key. A notification message 115 is then sent by the telephony station to the proxy in order to give notification of the pressing of the # key (also known as the Flash or Recall# key). Following the pressing of this key, the PROXY sends a notification message 116 sending the tone corresponding to the availability for the second call. In this particular configuration case, the user will use a shortcut key to contact a second remote station. Since the pressing of this key corresponds to a complete telephone number, a single message 117 is sent by the telephony station to give notification of the totality of the key sequence corresponding to the memorized telephone number. In response to this notification 117, the PROXY sends an end of tone notification message 118 to the telephony station to indicate thereto that the key sequence has taken effect. Thereafter, the PROXY carries out a step 119 of establishing contact, corresponding to a second call, with the second remote station which is for example not available. Following this step, it sends a tone notification message 120 for a tone signifying that the line is busy. During a step 121, the user aborts his second call attempt and resumes the first call by pressing a key on the telephony station. A message 122 is then sent to the PROXY in order to provide the notification of the key or of the corresponding sequence of keys. The call between the telephony station and the remote station then continues as before until a line on-hook event 123 by the user of the telephony station.

As already previously indicated, the message interchanges between the telephony station and the PROXY are carried out according to the SIP protocol. The advantage of these messages is that they are at an application protocol level. The messages thus sent are relatively short messages requiring little bandwidth on the network. For example, the various messages sent will now be given in slightly greater detail. First of all the subscription messages correspond to the message of the “SUBSCRIBE” type of the SIP protocol. These messages comprise a header defined by the protocol in which are given the address of the entity requesting the subscription, the address of the entity to which subscription is desired so that the message is correctly sent. In addition, a request number and the type of subscription desired and the duration for which the subscription is desired are also indicated. Each subscription message is clearly immediately followed in return by an acknowledgement message specifying the address of the entity that has received the message, the address of the entity that has sent the message and the references to the message necessary for identifying the message that has just been received.

As an example, the subscription message sent by the telephony station to the PROXY to subscribe to the tone service is in the following form:

SUBSCRIBE sip : IP proxy address SIP/2.0 Call-Id: 4584@ IP phone address To: <sip: >IP proxy address From: <sip:>202@ IP phone address ;tag=3521 CSeq: 12 SUBSCRIBE Event: telephone-event Expires: 7200 Content-Length: 0

The subscription message sent by the PROXY to the telephony station to subscribe to the event service is for example in the following form:

SUBSCRIBE sip : 202 @ IP phone address SIP/2.0 Call-Id: 62@ Ip proxy address To: <sip: >202@ IP phone address From: <sip:>Ip proxy address ;tag=abcd CSeq: 1 SUBSCRIBE Event: telephone-event Expires: 7200 Content-Length: 0

Those skilled in the art will notice that the (“event”) subscription service is the same even though the telephony station and the PROXY do not supply the same service. However, these two services being complementary, it is normal to use one and the same name. The 7200 ms subscription duration is fixed arbitrarily; this duration needs to be fixed so that it is long enough to avoid too many resubscriptions and short enough to terminate the subscription rapidly if the telephony station is taken out of service.

The notification messages are messages of the “NOTIFY” type according to the SIP protocol. These messages comprise the address of the one sending the message; the address of the recipient of the message, a message identifier, the identification of the service, the state of the subscription and the type of content. The content may be relatively small. As an example, a simple tone notification is sent in the following format:

NOTIFY sips: 202@ IP phone address SIP/2.0 Call-Id: 4584@ IP phone address From: <sip: >IP proxy address ; tag=cvbn To: <sip:>202@ IP phone address ;tag=3521 CSeq: 1 NOTIFY Event: telephone-event; rate=1000 Subscription-State: active Content-Type: audio/telephone-event Content-Disposition: render Content-Length: 4 XXXX

The four content bytes indicated by XXXX correspond to a tone identifier frame. The frame used corresponds for example to the MIME (Multipurpose Internet Mail Extension) described in RFC2833 paragraphs 3.5 to 3.14. The MIME used has for example the following known format:

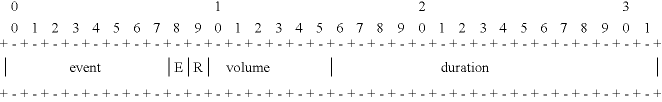

In this MIME, “event” corresponds to a code on 7 bits identifying the tone, for example as indicated in table 4, paragraph 3.12 of RFC2833 or in table 5, paragraph 3.14 of RFC2833, “duration” corresponds to the duration for which the tone must be active; this duration is encoded on 16 bits and must be multiplied by 125 us to obtain the real duration. The other parameters are of no use and the corresponding bits may be set at zero. It is also possible to use a MIME describing the tone. Use may be made for example of the MIME described in paragraph 4.4 of RFC2833 which occupies 8 bytes and corresponds to the following known format:

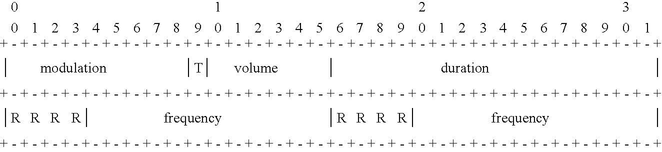

The tones are then described with a Hertz modulation parameter for which zero corresponds to no modulation. A volume parameter indicates the volume of the tone. A duration parameter indicates the duration for which the tone must be active. Two frequency parameters indicate the tone frequency or frequencies, one tone being capable of being the sum of two frequencies.

Preferentially, use is made of a MIME comprising, on the one hand, a tone identifier, and, on the other hand, a description of that tone. The MIME is for example in the following form, on 12 bytes if it is a continuous tone:

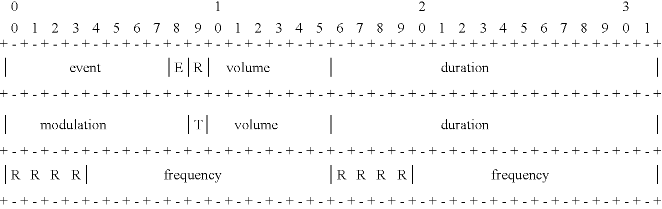

The tone may be an alternation of two tones. The description may then comprise a sequence of descriptive elements. It could for example be the following MIME which is 20 bytes long:

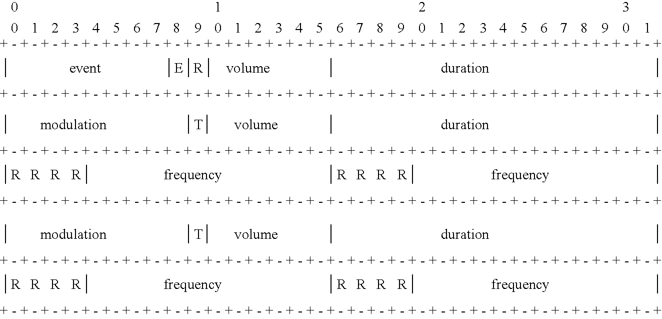

The tone notification messages must be regularly repeated at least for each duration for which the tone is sent. Thus, for a tone signifying that the line is available, this tone will be sent, for example, for a duration of one second and be repeated by the PROXY so long as no notification signifying that a key press event has been performed by the user.

To reproduce the tone, the telephony station must be provided with a tone synthesizer intended to create a tone in response to the tone notifications. The tone is reproduced either from the code representative of the tone, or from the description of the tone. The sound synthesis means may be extremely varied as may be the tone identification means. That is why it is preferable to send the description and the identifier in order to allow greater freedom in the design of the telephony station.

The key event notifications are of the same type as the tone notifications except that the content will correspond to an event representative of a DTMF code. As an example, a simple notification of DTMF code is sent according to the following format:

NOTIFY sip: IP proxy address SIP/2.0 To: <sip: >IP proxy address ;tag=abcd From: <sip:>202@ IP phone address ;tag=12345 Call-Id: 62@ Ip proxy address CSeq: 1 NOTIFY Event: telephone-event;rate=1000 Subscription-State: active Content-Type: audio/telephone-event Content-Length: 4 xxxx

The four content bytes indicated by XXXX correspond to a frame identifying the tone or the DTMF signals. The frame used corresponds for example to the MIME described in RFC2833, paragraphs 3.5 to 3.14. The MIME used has for example the following known format:

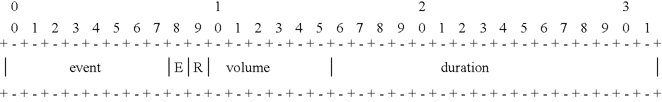

In this MIME, “event” corresponds to a code on 7 bits identifying the code of the DTMF signal, for example as indicated in table 1, paragraph 3.10 of RFC2833, “duration” corresponds to the duration for which the key has been pressed; this duration is encoded on 16 bits and must be multiplied by 125 μs to obtain the real duration. The duration of the key press may be used to distinguish long presses from short presses which may be interpreted differently in certain cases. The other parameters are of no use and the corresponding bits may be set at zero.

Several key press events may be sent with one and the same message. The MIME sent then corresponds to the succession of keys that have been used. If for example use is made of a shortcut key to indicate a telephone number corresponding to 10 digits, the content of the message will be 40 bytes corresponding to 10 times the preceding MIME.

It is also possible to use a MIME describing the DTMF signal. Use may also be made, for example, of the MIME described in paragraph 4.4 of RFC2833 which occupies 8 bytes and which corresponds to the following known format:

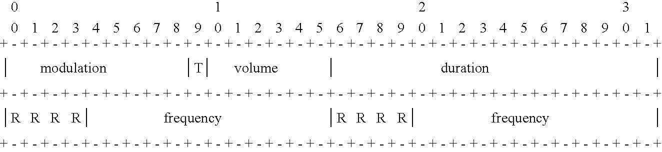

The modulation parameter always equals zero. The volume parameter indicates the volume of the DTMF signal; it is for example always equal to one and the same value. The duration parameter indicates the duration for which the key is pressed. Two frequency parameters indicate the two frequencies comprising a DTMF signal.

Preferentially, use is made of a MIME comprising, on the one hand, an identifier of the DTMF signal, and, on the other hand, a description of this DTMF signal. The MIME has for example the following form on 12 bytes:

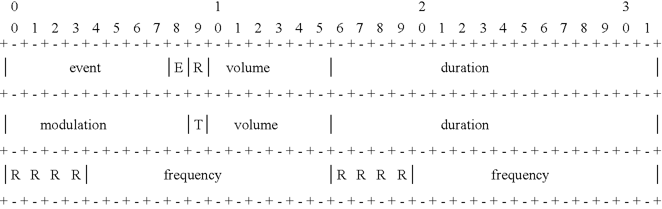

If a succession of keys is sent with one and the same message, the above MIME is repeated as many times as necessary in the message.

The invitations to contact the remote station are made with the aid of an “INVITE” message as is currently used for establishing the call between a calling telephony station and a remote called station. Equally the line seizure information is given as already known with the aid for example of “INFO” or “INVITE” messages.

Thus, according to the invention, the protocol messages linked to a call are broken down into two message types. A first message type manages the interaction between a telephony station and the server which is uniquely associated with it. The first message type corresponds to the notifications using the “NOTIFY” messages. A second message type manages an establishment operation for a telephone call between the telephony station and the remote station. The second message type corresponds to messages of the “INVITE” or “INFO” type as used in the state of the art to initiate a telephone call. The messages of the second type are initiated by at least one exchange between the telephony station and its associated server before being redirected between the telephony station and the remote station in order to establish an audio channel. Those skilled in the art will note that in the state of the art, only the messages of the second type exist.

Many embodiment variants are possible based on the foregoing description. In particular, the telephony station subscription to the tone service is described as being made immediately in response to a startup of the telephony station, then the server subscription to the event service is made following the preceding subscription. It is quite possible to have an inversion in these subscriptions. For example, the server may be informed of the installation of a new telephony station on the network before the latter has subscribed to the tone service. The server may in this case be the first to subscribe with the telephony station.

What is claimed is:

1. A method of managing telephone calls over a data network comprising at least one server and at least one telephony station, the data network supporting at least one data protocol distinct from a communication protocol,
wherein following a startup of the telephony station, the establishment of the call is initiated by a reciprocal exchange of protocol messages between the telephony station and the server, said protocol messages being of a first type and of a second type,
wherein the protocol messages of the first type are always exchanged between the telephony station and the server,
wherein the protocol messages of the second type are, in a first time, exchanged between the telephony station and the server, then, in a second time, between the telephony station and a station known as remote when the call is established,
wherein said protocol messages of the first type sent by the telephony station to the server are protocol messages relating to key press events,
wherein said protocol messages of the first type sent by the server to the telephony station are messages representative of the tones which are to be heard by a user of the telephony station in order to inform him of the state of establishment of the telephone call,
and wherein said protocol messages of the first type conform with the data protocol.

2. The method as claimed in claim 1, wherein the data protocol provides the possibility of subscribing to services, and wherein, following the startup of the telephony station and prior to the exchange of the protocol messages:
the telephony station subscribes to a tone service with the server according to the data protocol, said service supplying the protocol messages representative of the tones, and
the server subscribes to an event service with the telephony station according to the data protocol, said service supplying the protocol messages relative to key press events.

3. The method as claimed in claim 1, wherein the protocol messages representative of the tones comprise a code identifying the tone.

4. The method as claimed in claim 1, wherein the protocol messages representative of the tones comprise a description of the tone which is to be heard by the user of the telephony station, the description including at least one of the following parameters:
a parameter representative of the frequency of the tone,
a parameter representative of the volume of the tone,
a parameter representative of the duration of the tone,
a parameter of modulation of the tone.

5. The method as claimed in claim 4, wherein several successive descriptions are sent simultaneously to describe a complex tone.

6. The method as claimed in claim 1, wherein the protocol messages relating to key press events comprise at least one code representative of an event created by the pressing of a control key on the telephony device by a user.

7. The method as claimed in claims 1, wherein the protocol messages relating to key press events comprise a description of a sound associated with an event created by the pressing of a control key on the telephony device by a user.

8. The method as claimed in claim 2, wherein, after an exchange of protocol messages of the second type between the telephony station and the server, the call between the telephony station and the remote station is established with the aid of the communication protocol, and wherein the subscriptions to the tone and event services are maintained between the telephony station and the server.

9. The method as claimed in claim 1, wherein the data protocol is the SIP protocol.

10. The method as claimed in claim 9, wherein the protocol messages of the first type correspond to messages of the NOTIFY type as defined in RFC3265.

11. A telephony station comprising means of connection to a data network that supports at least one communication protocol and one data protocol allowing subscription to a service, which comprises:
subscription means intended for subscribing, following its startup on the data network, to a tone service with a server connected to the network, the tone service supplying notifications of tones in protocol message form, and
notification means intended to send event notifications in the form of protocol messages to the server, following a subscription by the server to an event service with the telephony station.

12. The telephony station as claimed in claim 11, which comprises a tone synthesizer intended to create a tone in response to the tone notifications, the notifications comprising a code representative of the tone that is to be heard by a user of the telephony station and/or a description of the tone that is to be heard by the user of the telephony station, the description being able to include:
a parameter representative of the frequency of the tone,
a parameter representative of the volume of the tone,
a parameter representative of the duration of the tone,
a parameter of modulation of the tone.

13. The telephony station as claimed in claim 11, which comprises an encoder intended to encode an event created by the pressing of a control key on the telephony station by a user and means intended to send a protocol message to the server, following the subscription to the event service, the protocol message including a code representative of the event and/or a description of a sound associated with the created event.

14. The telephony station as claimed in claim 11, which comprises means for establishing a call according to the communication protocol with a remote station by sending data packets corresponding to audio.

15. A server comprising means of connection to a data exchange network which supports at least one communication protocol and one data protocol allowing subscription to a service, which comprises:
notification means intended to send tone notifications in the form of protocol messages to a telephony station connected to the network, following a subscription by the telephony station to a tone service with the server,
subscription means intended to subscribe to an event service with the telephony station connected to the network, following a detection of startup of the telephony station or following the subscription by the telephony station to the tone service, the event management service supplying event notifications in protocol message form.

16. The server as claimed in claim 15, which comprises:
means for contacting a remote station identified by event notifications,
means for defining a tone and creating the corresponding tone notification in response to a state of establishment of communication with the remote station.

17. A telephony system comprising:
at least one server comprising means of connection to a data exchange network which supports at least one communication protocol and one data protocol allowing subscription to a service, which further comprises:
server notification means intended to send tone notifications in the form of protocol messages to a telephony station connected to the network, following a subscription by the telephony station to a tone service with the server,
server subscription means intended to subscribe to an event service with the telephony station connected to the network, following a detection of startup of the telephony station or following the subscription by the telephony station to the tone service, the event management service supplying event notifications in protocol message form,
at least one telephony station comprising means of connection to the data exchange network which further comprises:
phone subscription means intended for subscribing, following its startup on the data network, to the tone service with a server connected to the network, the tone service supplying notifications of tones in protocol message form, and
phone notification means intended to send event notifications in the form of protocol messages to the server, following a subscription by the server to the event service with the telephony station.

18. The system as claimed in claim 17, in which the data protocol is the SIP protocol.

19. The system as claimed in claim 18, in which the subscriptions are made with the aid of SUBSCRIBE messages as defined in RFC3265, and the notifications correspond to messages of the NOTIFY type as defined in RFC3265.

20. The system as claimed in claim 17, wherein the telephony station comprises a tone synthesizer intended to create a tone in response to the tone notifications, the notifications comprising a code representative of the tone that is to be heard by a user of the telephony station and/or a description of the tone that is to be heard by the user of the telephony station, the description being able to include:
a parameter representative of the frequency of the tone,
a parameter representative of the volume of the tone,
a parameter representative of the duration of the tone,
a parameter of modulation of the tone.

21. The system as claimed in claim 17, wherein the telephony station comprises an encoder intended to encode an event created by the pressing of a control key on the telephony station by a user and means intended to send a protocol message to the server, following the subscription to the event service, the protocol message including a code representative of the event and/or a description of a sound associated with the created event.

22. The system as claimed in claim 17, wherein the telephony station comprises means for establishing a call according to the communication protocol with a remote station by sending data packets corresponding to audio.

23. The system as claimed in claim 17, wherein the server comprises:
means for contacting a remote station identified by event notifications,
means for defining a tone and creating the corresponding tone notification in response to a state of establishment of communication with the remote station.
